(19) United States
(12) Patent Application Publication
(10) Pub. No.: US 2008/0191549 A1
(43) Pub. Date: Aug. 14, 2008

(54) Pressure Generator for a Vehicle Brake System and Method for Mounting Said Pressure Generator

(75) Inventors: Wilfried Giering, Mendig (DE); Werner Seibert, Kammerforst (DE); Benedikt Ohlig, Vallendar (DE); Leo Gilles, Koblenz (DE); Josef Knechtges, Mayen (DE)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: LUCAS AUTOMOTIVE GMBH, Koblenz (DE)

(21) Appl. No.: 11/792,476

(22) PCT Filed: Dec. 5, 2005
(86) PCT No.: PCT/EP05/13028

§ 371 Date: Jun. 6, 2007

(30) Foreign Application Priority Data
Dec. 6, 2004 (DE) 10 2004 058 726.4

(51) Int. Cl. B60T 8/40; F04B 1/00

(52) U.S. Cl. 303/116.4

(57) ABSTRACT

What is described is a pressure generator for a vehicle brake system and also a method for mounting said pressure generator in said vehicle brake system. The pressure generator possesses a modular construction consisting of a pump subassembly and a receiving housing for said subassembly. The housing is designed in such a way that it has at least one fluid connection which, when the pressure generator is in the mounted state, is connected to a fluid inlet or a fluid outlet on a cylinder block belonging to the pump subassembly. Said pump subassembly is preferably constructed as a multi-piston pump and may comprise an actuating unit for the asynchronous actuation of the pumping pistons.

### CROSS-REFERENCE TO RELATED APPLICATIONS

This application is a National Stage of International Application No. PCT/EP2005/013028 filed Dec. 5, 2005, the disclosures of which are incorporated herein by reference, and which claimed priority to German Patent Application No. 10 2004 058 726.4 filed Dec. 6, 2004, the disclosures of which are incorporated herein by reference.

### BACKGROUND OF THE INVENTION

The invention relates to a pressure generator for a hydraulic or electrohydraulic vehicle brake system. The invention also relates to a method for mounting the said pressure generator.

Modern hydraulic or electrohydraulic vehicle brake systems require reliable pressure generators in order to be able to implement systems which are relevant to safety, such as a hydraulic brake-force booster system, an anti-locking system (ABS), a distance-regulating system (ACC) or a drive-slip-regulating system (ASR). In these systems, a hydraulic pressure is generated by means of a pressure generator for the purpose of activating one or more wheel brakes.

In the past, use has frequently been made, for the purpose of making the hydraulic pressure available, of pressure reservoirs of the diaphragm type, such as are described in DE 101 46 367 A. Pressure reservoirs of this type are charged with hydraulic fluid by means of a pump, store said hydraulic fluid at a predetermined pressure, and feed the pressurized hydraulic fluid to the brake circuit, for example in the event of a regulating intervention by the ABS. What is advantageous about this is that the flow of fluid is fed into the brake circuit in a pulsation-free manner from the pressure reservoir, so that the driver of the motor vehicle frequently has no immediate perception at all of the regulating intervention.

For reasons of cost, and also because of the disadvantageous effects of ageing of the pressure reservoir diaphragm, consideration has been given to dispensing with the pressure reservoir and generating the hydraulic pressure directly, if and when required, by means of a pump. In the case of conventional pumps, however, it has been observed that these generate high pressure pulsations when regulating interventions occur. Pressure pulsations of this type reduce the convenience of operation in some situations, since they are interpreted by the driver as malfunctioning and, moreover, are frequently accompanied by unpleasant noises.

It has been found that greater convenience of operation ensues if the conventional (single-piston) pumps are replaced by multi-piston pumps. In the latter, the individual pistons can be activated asynchronously, so that pressure pulsations are markedly smoothed as a result of the superposition of intake strokes and pressure strokes of the individual cylinder/piston arrangements.

As a result of the plurality of pump pistons however, known multi-piston pumps frequently have a complex construction and one which is therefore cost-intensive and not very conducive to mounting, especially as said pump pistons have to be accommodated in a manner appropriate to the drive and a large number of connecting ducts, both between the individual cylinder/piston arrangements and also to fluid connections, frequently have to be constructed. But even in the case of single-piston pumps, mounting and, above all, the replacement of the pressure generator is not simple.

The underlying object of the invention is to indicate a pressure generator of the single-piston or multi-piston type, and one which can be mounted easily. Another underlying object of the invention is to indicate a method for mounting the pressure generator.

### BRIEF SUMMARY OF THE INVENTION

According to a first aspect of the invention, this object is achieved by means of a pressure generator for a vehicle brake system, comprising a pump subassembly, which can be handled individually (separately), with a cylinder block with at least one inlet for a hydraulic fluid and at least one outlet for said hydraulic fluid, wherein in said cylinder block one, two or more cylinders are arranged, in each of which a pumping piston is received, and with an actuating unit for said pumping pistons. The pressure generator further comprises a housing for receiving, at least partially, the pump subassembly, wherein said housing has at least one first fluid connection and connects the inlet or outlet on the cylinder block to said first fluid connection.

The provision of a pump subassembly which can be handled individually makes it possible to separate the functions of cylinder block and receiving housing. This separation permits optimization of both the cylinder block and the receiving housing with regard to the respective functionality. In addition, simpler mounting and improved maintainability of the pressure generator is achieved by means of a pump subassembly which can be handled individually.

In addition to the first fluid connection, the receiving housing may have at least one second fluid connection, the housing (in the case of a pump subassembly which is inserted in said housing) connecting the first fluid connection to the inlet on the cylinder block, and the second fluid connection to the outlet on the pump subassembly. The first fluid connection, which is coupled to the inlet, is expediently provided for a source of fluid (for example for a fluid reservoir or a main brake cylinder). The second fluid connection, which is coupled to the outlet, may be coupled to at least one hydraulic circuit (for example to a brake circuit). According to this variant form of connection, the receiving housing thus functions both as an interface between the at least one inlet on the cylinder block and the source of fluid, and also as an interface between the at least one outlet and one or more hydraulic circuits. According to one alternative variant, the receiving housing fulfills only one of these two interface functions. Thus, either the source of fluid or at least one of the hydraulic circuits could also be connected directly to the inlet or outlet on the cylinder block.

The cylinder block may have at least one cylinder aperture in a region adjoining the receiving housing. It would also be conceivable for each cylinder to possess a cylinder aperture of this kind which adjoins the housing. Said cylinder aperture may be bounded by a closing element (for example by an occluding plug or by a fluidics control element such as a valve) and/or by the housing. Each cylinder aperture may be provided with a closing element of its own. However, it is also conceivable to provide a common closing element (for example one which encloses the cylinder block) for two or more or all of the cylinder apertures.

The closing element may be coupled to the cylinder block in such a way that it is supported against the housing when the pressure generator is in operation. Said closing element therefore does not have to be fastened on or in the cylinder block by means of (screwed or caulked) connections which withstand high pressure. On the contrary, it is possible to achieve coupling, which is reliable even when acted upon by pressure, of the at least one closing element to the cylinder block through the fact that the at least one closing element rests against the housing when the pump subassembly is in the mounted state.

When a plurality of cylinders is provided in the cylinder block, said cylinders may have different, fixedly predetermined orientations relative to one another, within said cylinder block. According to one first variant, the cylinders are arranged in a star-shaped manner in the cylinder block. Thus, said cylinders may extend substantially radially with respect to a driving axis. According to another variant, the cylinders run parallel to one another within the cylinder block.

The cylinder block may have an even or an odd number of cylinder/piston arrangements. Thus 3, 4, 5 or 6 or more cylinders, with pumping pistons received therein, may be provided. The number of cylinder/piston arrangements used also depends upon the particular requirements. Thus, in a vehicle brake system having two or more hydraulic circuits, at least one cylinder/piston arrangement may be connected per hydraulic circuit. In order to make a higher hydraulic pressure available, two or more cylinder/piston arrangements may be provided per hydraulic circuit. Said cylinder/piston arrangements may be actuated synchronously or asynchronously by the actuating unit. In order to smooth pulsation peaks, it is expedient to provide at least two asynchronously actuated cylinder/piston arrangements per hydraulic circuit.

The pressure generator may be constructed for coupling to two or more hydraulic circuits. In this case, at least one cylinder/piston arrangement may be provided in the cylinder block for each hydraulic circuit. According to one variant, there are constructed in the cylinder block at least one cylinder/piston arrangement for a brake-force booster circuit and at least one further cylinder/piston arrangement for each of two ABS circuits. All said cylinder/piston arrangements are expediently actuated by a common actuating unit.

The pump subassembly may be coupled to the receiving housing in various ways. It has proved expedient to arrange said pump subassembly in the receiving housing in a detachable manner. In this connection, a screwed connection or clamped connection may be contemplated. However, a non-detachable connection between the pump subassembly and the housing is also a possibility.

The dividing-up of the pressure generator into a pump subassembly which can be handled individually, on the one hand, and a receiving housing for said subassembly on the other, makes it possible to optimize these two components according to their specific functionalities. Thus, the receiving housing can be manufactured from a different material from the cylinder block. Said housing may consist, for example, of a solid first material such as aluminum, in which it is possible, in a simple manner, to construct fluid lines and to provide fluidics control elements such as valves (a “valve block”). The cylinder block, on the other hand, may consist of a particularly wear-resistant second material such as steel or grey cast iron.

The actuating unit for the pumping pistons may comprise various components. Thus, for example, said actuating unit may have an eccentric or a swash plate in order to permit asynchronous actuation of the pumping pistons. The actuating unit may also comprise an electric motor which permits cyclical actuation of the pumping pistons. The actuating unit may be provided with a housing of its own, which is fastened to the cylinder block.

According to a second aspect of the invention, a method for mounting a pressure generator in a vehicle brake system is provided. Said method comprises the steps of providing a housing for receiving at least one section of a pump subassembly, wherein said housing has at least one fluid connection, and of providing a pump subassembly, which can be handled individually, with a cylinder block with at least one inlet for a hydraulic fluid and at least one outlet for said hydraulic fluid, wherein in said cylinder block one, two or more cylinders are arranged, in each of which a pumping piston is received, and with an actuating unit for said pumping pistons. The method comprises the further steps of connecting the housing by the connection of the fluid connection to a source of fluid or to a hydraulic circuit, and of inserting the pump subassembly in the housing, wherein the inlet or outlet on the cylinder block is connected to the fluid connection.

If the housing has two or more fluid connections, at least one first fluid connection may be connected to a source of fluid, and at least one second fluid connection may be connected to at least one hydraulic circuit, when the housing is connected. In this case, the insertion of the pump subassembly in the housing may take place in such a way that the inlet on the cylinder block is connected to the source of fluid via a suitable fluid connection on the housing, and the outlet is connected to at least one hydraulic circuit via another fluid connection on the housing.

The modular subdivision of the pressure generator into a pump subassembly which can be handled individually, on the one hand, and a receiving housing for the said pump subassembly on the other, makes it possible for said receiving housing to be connected in a first step as explained above, and for the pump subassembly to be inserted, in a second step, in the housing which has already been connected. However, it would also be conceivable for the pump subassembly to be inserted in the housing even before the latter is connected, and for the fully assembled pressure generator to then be connected to the vehicle brake system.

It is also possible to provide a plurality of pump subassemblies with different capacities (for example different numbers of cylinder/piston arrangements) and to select, and insert in the housing, a specific type of pump subassembly in dependence upon the capacity required.

Modular attachment has substantial advantages, both on the production side and also in the context of a vehicle service and when replacing a defective subassembly. Thus, for example, a defective pump subassembly can be demounted from the connected housing, and the repaired pump subassembly, or a new one, can be inserted in the latter. The receiving housing does not have to be disconnected from the vehicle brake system during this operation.

At this point, it should further be pointed out that some of the aspects according to the invention, in particular the connection of the cylinder/piston arrangements to a vehicle brake system and also the distribution of the individual cylinder/piston arrangements over the individual hydraulic circuits of such a system, can also be implemented independently of the modular concept. It would therefore be possible, for example, to construct the cylinder block and the housing in one piece (for instance in the form of a solid metal block).

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a first embodiment of a pressure generator according to the invention in a perspective view;

FIG. 2 shows the pressure generator according to FIG. 1 in a partly exploded representation;

FIG. 3 shows the pressure generator according to FIG. 1 in a partly sectional view;

FIG. 4 shows the cylinder block of the pressure generator according to FIG. 1 in longitudinal section;

FIG. 5 shows a perspective view of that side of the cylinder block according to FIG. 4 which faces towards a receiving housing;

FIG. 6 shows a perspective view of a side of the cylinder block according to FIG. 4 that faces away from the receiving housing;

FIG. 7 shows a perspective view of a pump subassembly that can be handled independently according to a further exemplified embodiment of the invention;

FIG. 8 shows a front view of the pump subassembly according to FIG. 7;

FIG. 9 shows a rear view of the pump subassembly according to FIG. 7;

FIG. 10 shows a longitudinal section through the pump subassembly according to FIG. 7;

FIG. 11 shows a cross-section through the pump subassembly according to FIG. 7, in the region of a cylinder block;

FIG. 12 shows an enlarged detail from FIG. 11;

FIG. 13 shows a perspective view of a pressure generator according to another embodiment of the invention;

FIG. 14 shows a longitudinal section through the pressure generator according to FIG. 13;

FIG. 15 shows an enlarged region of another longitudinal section through the pressure generator according to FIG. 13;

FIGS. 16 to 19 show various cross-sectional views of the pressure generator according to FIG. 13;

FIG. 20 shows a multi-circuit vehicle brake system, with a diagrammatic representation of the individual cylinder/piston arrangements of a pressure generator according to the invention, according to another embodiment of the invention; and

FIG. 21 shows a diagrammatic representation of the cylinder block of the pressure generator according to FIG. 20.

### DETAILED DESCRIPTION OF THE INVENTION

Various multi-piston pump pressure generators for use in hydraulic or electrohydraulic vehicle brake systems will be described below. The pressure generators put forward supply the hydraulic pressure needed for activating one or more wheel brakes and may, for example, be a constituent part of a hydraulic brake-force booster system or an ABS, ASR, ACC or VSC (vehicle stability control, also referred to as “ESP”) regulating apparatus.

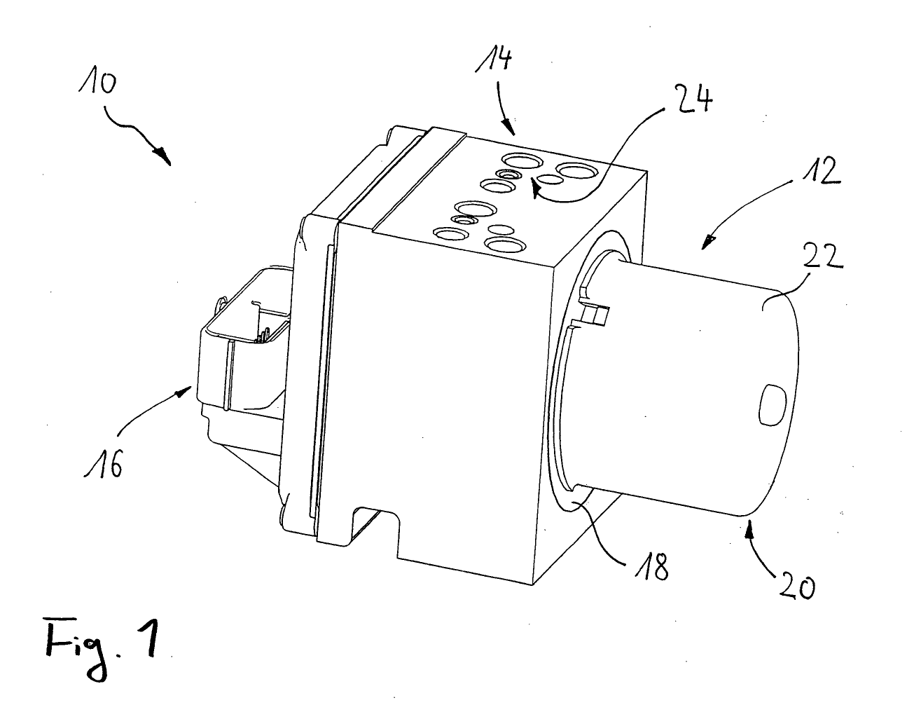

FIG. 1 shows a perspective view of a first embodiment of a pressure generator 10 according to the invention for a vehicle braking system, in the finally assembled state. Said pressure generator 10 is suitable, for example, for implementing a VSC regulating apparatus.

The pressure generator 10 according to FIG. 1 comprises a pump subassembly 12 which can be handled separately and which is received, partially, in a receiving housing 14 in the form of a solid aluminum block with fluid lines constructed therein and fluidics control elements arranged therein. The pressure generator 10 comprises, as the third main component, a unit 16, which is screwed onto the housing 14, for making contact with the electrical components of the pressure generator 10.

The pump subassembly 12, which is partially inserted in the housing 14, comprises a circular-ring-shaped cylinder block 18, which is only partly visible in FIG. 1 and is made of a wear-resistant material such as steel or grey cast iron, and also an actuating unit 20 which is fastened to the cylinder block 18. Said actuating unit 20 is received in a pot-shaped housing 22.

On its upper side, the receiving housing 14 for the pump subassembly 12 possesses a plurality of fluid connections 24. When the pressure generator 10 is in the finally mounted state, it is connected to a source of fluid, and also to one or more hydraulic circuits, by means of the fluid connections 24.

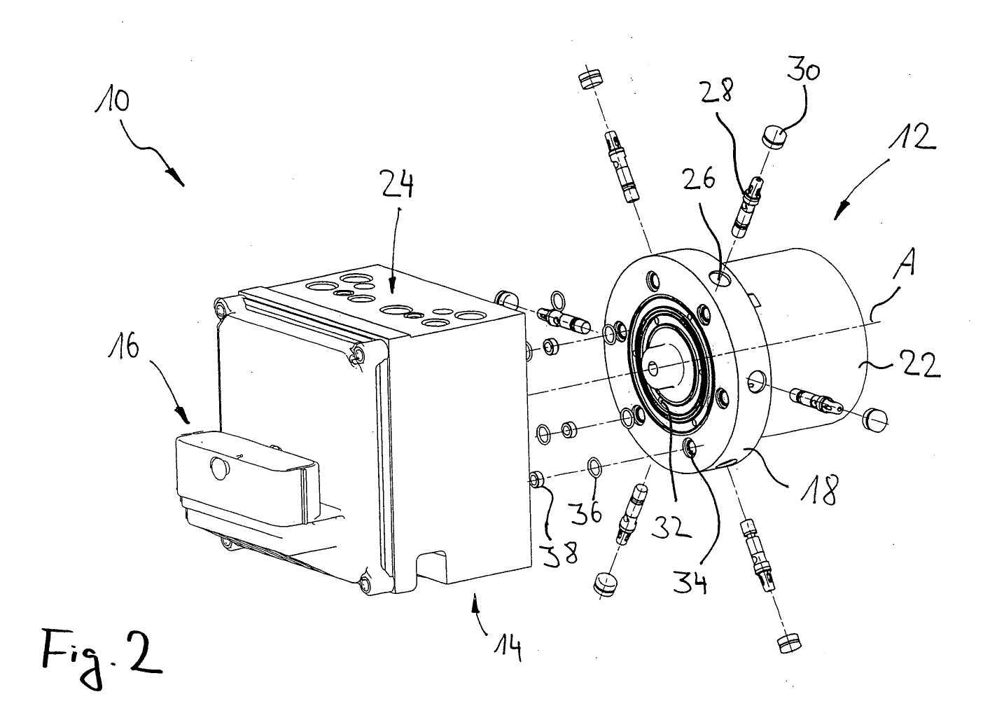

FIG. 2 shows another perspective view of the pressure generator 10, in which the pump subassembly 12 is represented in a partly exploded view. The annular construction of the cylinder block 18 can be clearly seen. A total of six cylinders are arranged in said cylinder block 18. Of these six cylinders, only a few cylinder apertures 26, which are constructed on the outer periphery of the cylinder block 18, can be seen in the view according to FIG. 2. When the pump subassembly 12 is in the mounted state, the cylinder apertures 26 adjoin an outer periphery of a pot-shaped clearance which is provided in the housing 14 for receiving the cylinder block 18. The cylinders, of which there are six in all, are arranged in a star-shaped manner in the cylinder block 18. In other words, said cylinders extend in radial directions with respect to a longitudinal axis A of the pump subassembly 12. For this reason, the pressure generator 10 is also referred to as a “radial multi-piston pump”.

A pumping piston 28 is received in a movable manner in each of the cylinders constructed in the cylinder block 18. When the pump subassembly 12 is mounted, the cylinder is occluded by means of a closing element 30 after one of the pumping pistons 28 has been introduced (through the corresponding cylinder aperture 26) into the cylinder provided for it in each case. In the embodiment according to FIG. 2, the closing element 30 is constructed as an occluding plug. Since said occluding plug can be supported against the housing 14 when the pressure generator, which has been finally mounted, is in operation, no particularly elaborate anchoring of the occluding plug in the appertaining cylinder is necessary. In particular, it is possible to dispense with conventional anchoring techniques such as a caulking operation or a threaded connection.

On its end face that faces towards the receiving housing 14, the cylinder block 18 has one fluid inlet 32, and also one fluid outlet 34, for each cylinder/piston arrangement. Each of the fluid outlets 34 opens, within the cylinder block 18, into a cylindrical depression, in each of which a sealing ring 36 and a connecting cylinder 38 are inserted.

When the pump subassembly 12 is inserted in the receiving housing 14, the fluid inlets 32 and fluid outlets 34 constructed on the cylinder block 18 are connected (via fluid lines and fluid control elements arranged in said housing 14) to the fluid connections 24 on the housing 14. Stated more precisely, the fluid inlets 32 on the cylinder block 18 are connected to a connection 24 for a source of fluid, and the fluid outlets 34 on the cylinder block 18 are connected to a connection 24 for one or more hydraulic circuits.

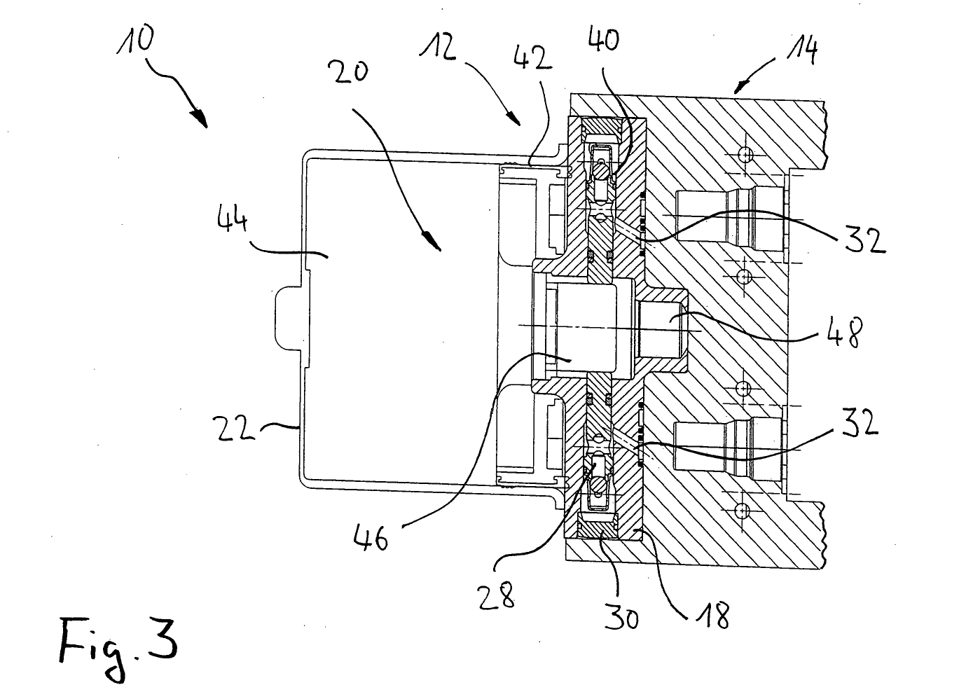

FIG. 3 shows a partial longitudinal section through the pressure generator 10 according to FIG. 1. The situation in which the pump subassembly 12, or more precisely the cylinder block 18, is inserted in a pot-shaped clearance 40 in the receiving housing 14 can be clearly seen. The insertion of the cylinder block 18 in the clearance 40 provided for it takes place in such a way that a detachable press fit is constructed between said cylinder block 18 and the receiving housing 14. The detachable construction of the press fit permits a subsequent replacement of the pump subassembly 12, without the receiving housing 14 having to be disconnected from the vehicle braking system.

The construction of the actuating unit 20 can be clearly seen in FIG. 3. Said actuating unit 20 comprises the pot-shaped housing 22 already mentioned, which is detachably fastened to the cylinder block 18 by means of clips 42. The actuating unit 20 also comprises an electric motor 44 which is arranged in the housing 22 and has an eccentric 46 which is attached to a motor shaft 48. The eccentricity of the eccentric 46 cannot be seen in the sectional representation according to FIG. 3.

The eccentric 46 interacts directly with those end faces of the pumping pistons 28 which are at the opposite end from the closing elements 30. This interaction takes place in an asynchronous manner because of the eccentricity of the eccentric 46. This means that at least some of the pumping pistons 28, of which there are six in all, are located in different operating positions, as regards the induction and expulsion of hydraulic fluid, at any point in time during the pumping operation. Unwanted pressure pulsations can be smoothed through the fact that two or more of the asynchronously actuated pumping pistons are connected to a single hydraulic circuit.

Another situation, which can be inferred from FIG. 3, is one in which the closing elements 30 can be supported against a circumferential inner wall of the clearance 40 in the housing when the pressure generator 10 is in operation. As has already been mentioned, this makes it possible to dispense with elaborate connecting techniques between the closing elements 30 and the cylinder block 18.

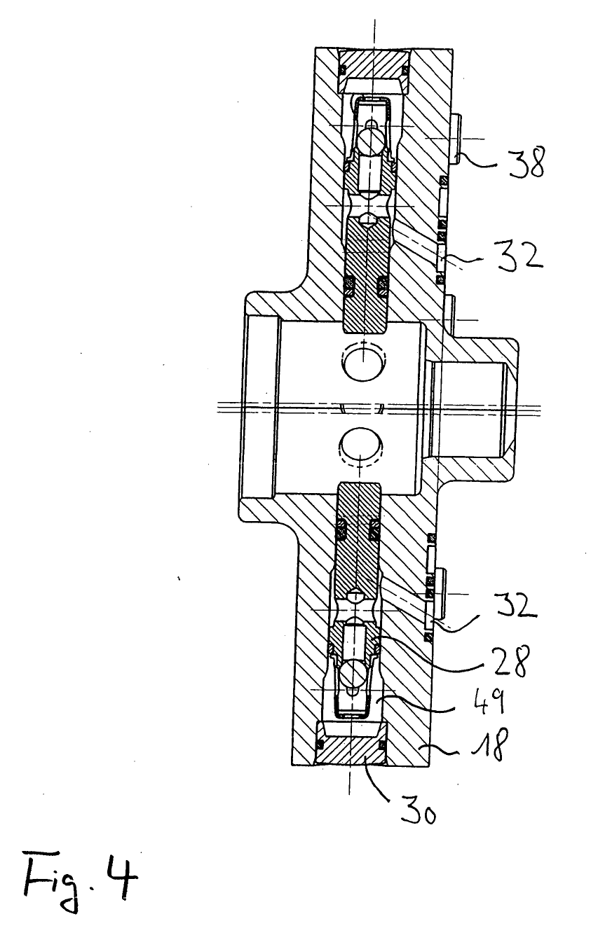

FIG. 4 shows a longitudinal section through the cylinder block 18, with the pumping pistons 28 received in cylinders 49 which are arranged in a star-shaped manner. The fluid inlets 32 and fluid outlets 38 on the cylinder block 18 can be clearly seen. It can likewise be seen that the closing elements 30 are fastened within the cylinder block 18 merely by means of a press fit (and not by means of the more elaborate fastening techniques already mentioned).

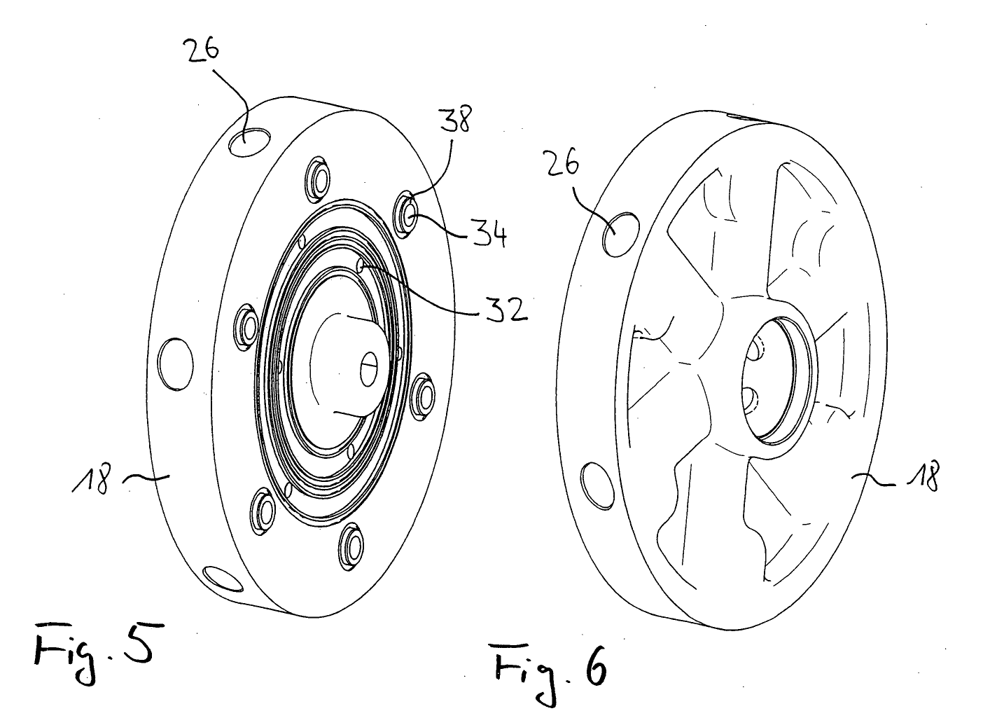

FIGS. 5 and 6 show the cylinder block 18, once again prior to the mounting of the pumping pistons 28 and the closing elements 30. FIG. 5 is a representation of that end face of the cylinder block 18 which faces towards the receiving housing 14 and which has the fluid inlets 32 and fluid outlets 34. FIG. 6 shows that rear side of the cylinder block 18 which faces towards the actuating unit and has the cylinder walls which are arranged in a star-shaped manner.

For the purpose of mounting the pressure generator 10 according to the first embodiment in a vehicle brake system, the pump subassembly 12 is inserted in the housing 14, as a result of which the inlets 32 and outlets 34 on the cylinder block 18 are connected to the corresponding fluid connections 24 on the housing 14. In the case of a dual-circuit vehicle brake system, it would be conceivable to couple three of the cylinder/piston arrangements, of which there are six in all, to a first hydraulic circuit, and the remaining three cylinder/piston arrangements to a second hydraulic circuit. In the case of a cylinder block having four or eight cylinder/piston arrangements, it would also be possible to implement wheel-selective activation.

The insertion of the pump subassembly 12 in the housing 14 may take place before or after the connection of said housing 14 to the vehicle brake system. The modular construction of the pressure generator 10 therefore makes it possible to replace the pump subassembly 12, without the housing 14 having to be disconnected from the vehicle brake system. It would also be conceivable to provide, for various types of motor vehicle, a single type of housing 14 which is combined with different types of pump subassemblies 12, according to the requirements in terms of capacity.

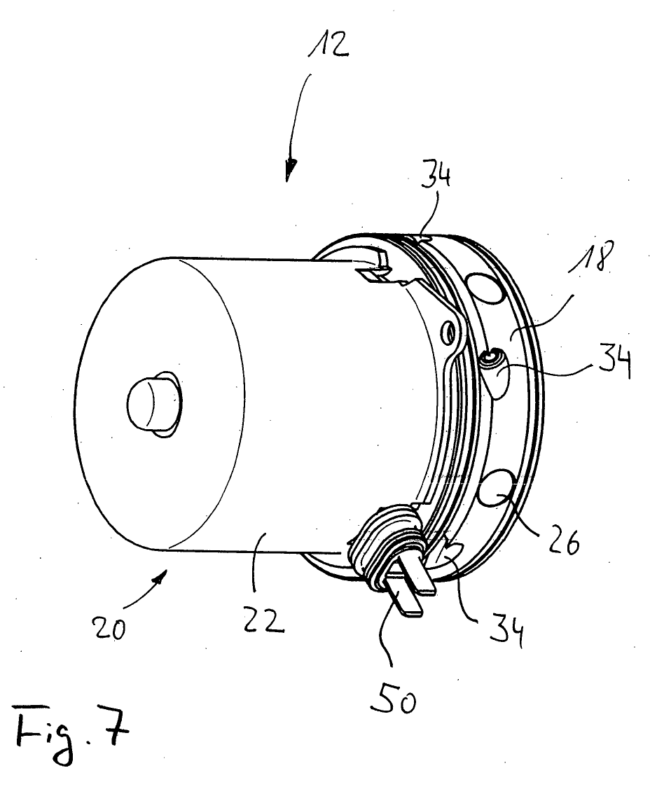

FIGS. 7 to 12 show a pump subassembly 12 according to a second embodiment. Elements which are identical have been provided with the same reference symbols as in the pump subassembly 12 in the first embodiment. Since there are major similarities between the pump subassemblies of the first and second embodiments, the following description of the second embodiment is confined to a discussion of the essential differences.

As emerges from the perspective view of the pump subassembly 12 in the second embodiment according to FIG. 7, the actuating unit 20 has an electrical connection 50 which is routed out of the housing 22 of said actuating unit 20. Said electrical connection 50 serves to supply an electric motor (not represented in FIG. 7), which is arranged in the housing 22 of the actuating unit 20, with electric power.

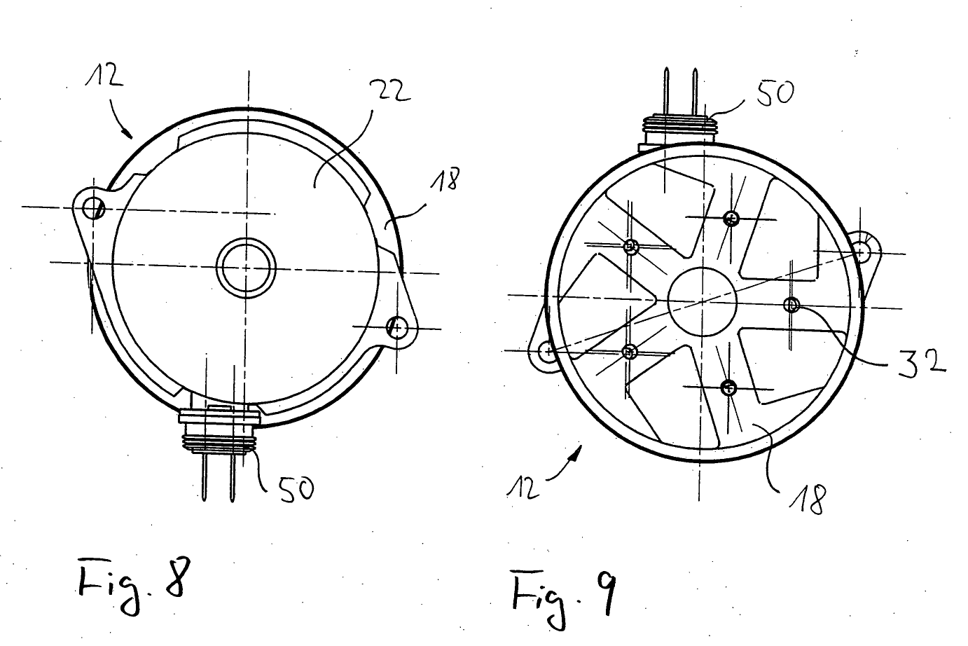

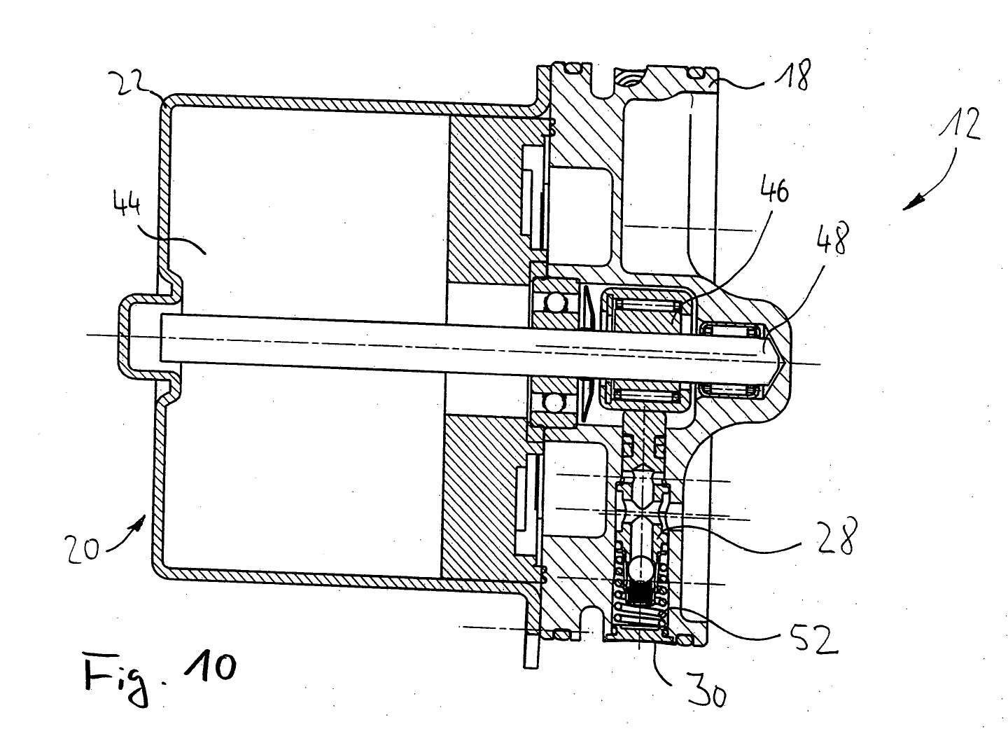

In contrast to the first embodiment, in the case of the pump subassembly 12 in the second embodiment, the fluid outlets 34 are arranged on the outer periphery of the annular cylinder block 18 and adjacent to the appertaining cylinder apertures 26. The fluid inlets 32 in the cylinder block 18 are constructed on that end face of the cylinder block 18 which faces towards a receiving housing, which is not represented, for the pump subassembly 12. This situation can be inferred from the front view of the subassembly according to FIG. 9, while FIG. 8 shows a rear view. It can also be seen, in FIG. 9, that only five cylinders are provided in the second exemplified embodiment. This situation is the result of the arms, of which there are five in all, of the star-shaped cylinder structure represented in FIG. 9.

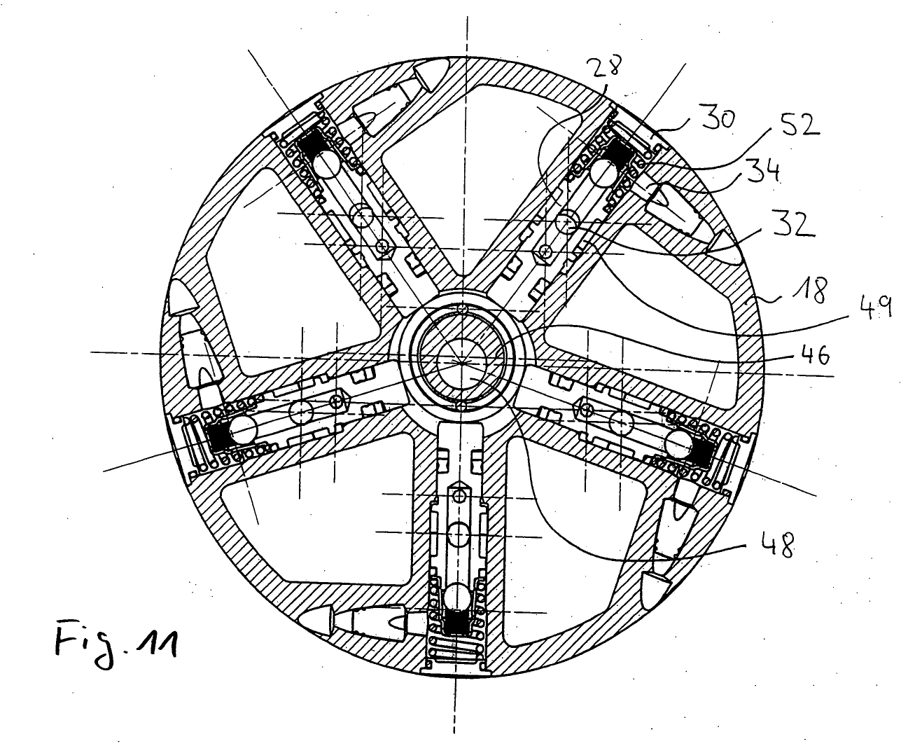

FIG. 10 shows a longitudinal section through the pump subassembly 12 according to the second embodiment. The eccentricity of the eccentric 46 mounted on the motor shaft 48 can be inferred, both from FIG. 10 and also from the section through the cylinder block 18 in the longitudinal direction according to FIG. 11. Both figures also show that an elastic element 52 in the form of a spiral spring is arranged in each cylinder 49 of the cylinder block 18 in the second embodiment, in addition to a pumping piston 28 and a closing element 30. Each spiral spring 52 pretensions the appertaining pumping piston 28 in the direction of the eccentric 46, and therefore guarantees that said pumping piston 28 is located in contact with said eccentric 46 in any operating position.

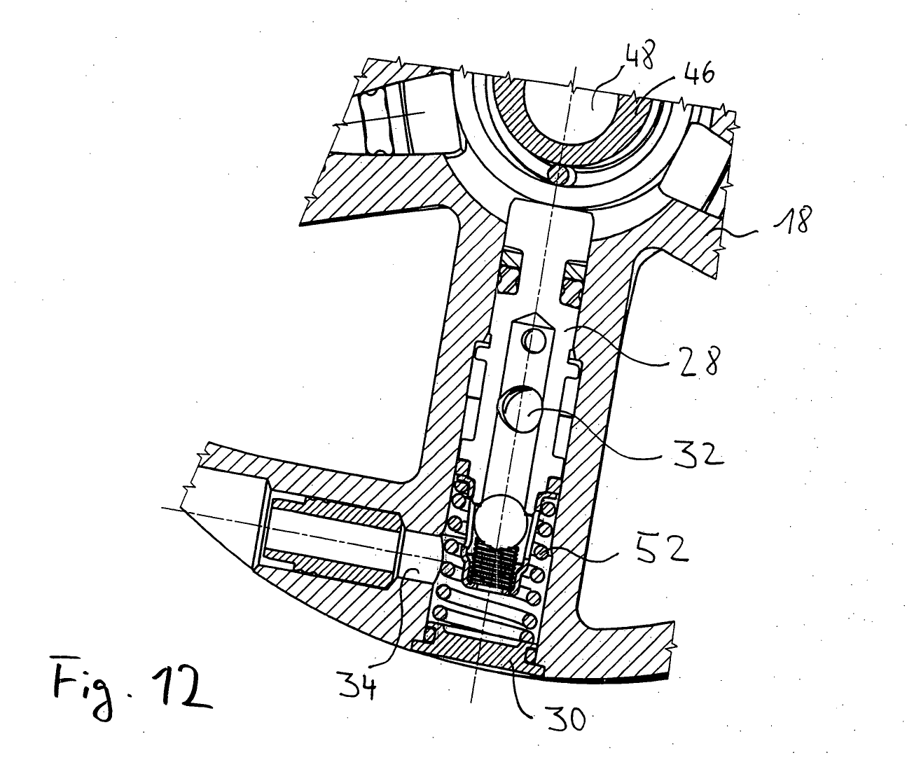

It has already been mentioned that the fluid inlets 32 and fluid outlets 34 on the cylinder block 18 have a different configuration from that in the first embodiment. As can be inferred from FIG. 11, the fluid outlets 34 extend substantially in the tangential direction within the circular-ring-shaped cylinder block 18, while the fluid inlets 32 run in the axial direction. This situation is represented particularly clearly in the detail enlargement according to FIG. 12.

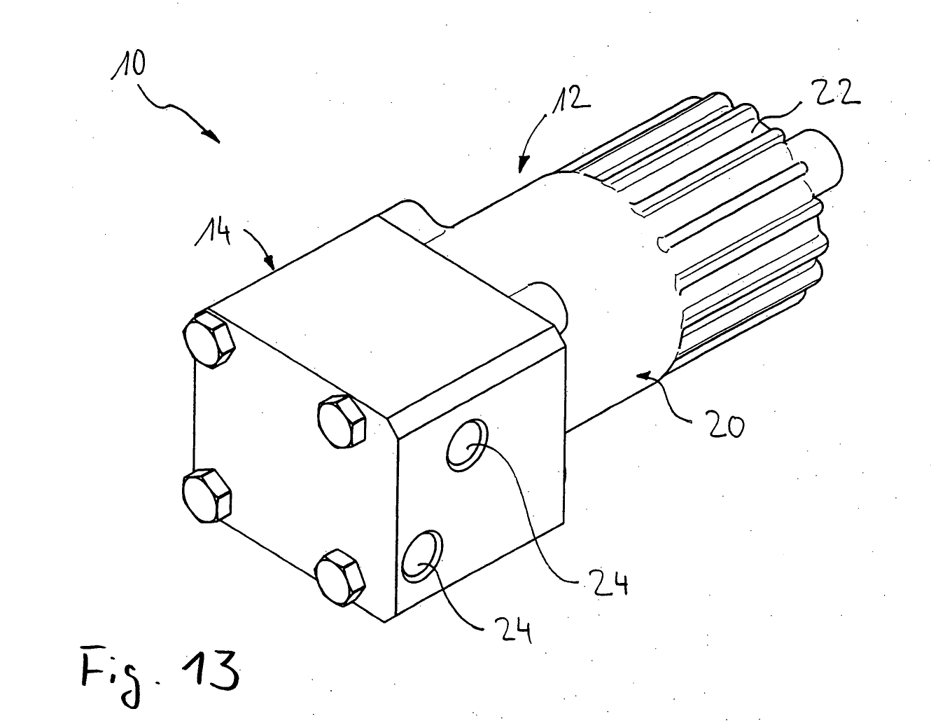

A third embodiment of the invention is shown in FIGS. 13 to 19. Whereas the pressure generators in the first two embodiments are also referred to as “radial multi-piston pumps” because of the radial arrangement of the cylinders within the cylinder block, the third exemplified embodiment relates to a so-called “axial multi-piston pump”. As may be supposed, merely from this designation, the cylinder/piston arrangements extend, in the case of the pressure generator in the third embodiment, in the axial direction with respect to a longitudinal axis of said pressure generator. In the third embodiment, elements which have identical functionality are identified by the same reference numerals as in the two preceding embodiments.

FIG. 13 shows a perspective view of the pressure generator 10 according to the third embodiment. Said pressure generator 10 comprises a receiving housing 14 in which, in certain regions, a pump subassembly 12 having a cylinder block (not visible) and an actuating unit 20 is received. Said actuating unit 20 is arranged in a housing 22. The pressure generator 10 according to the third embodiment may, for example, be used as a hydraulic brake-force booster and comprises one fluid connection 24, in each case, for a source of fluid and for a hydraulic circuit.

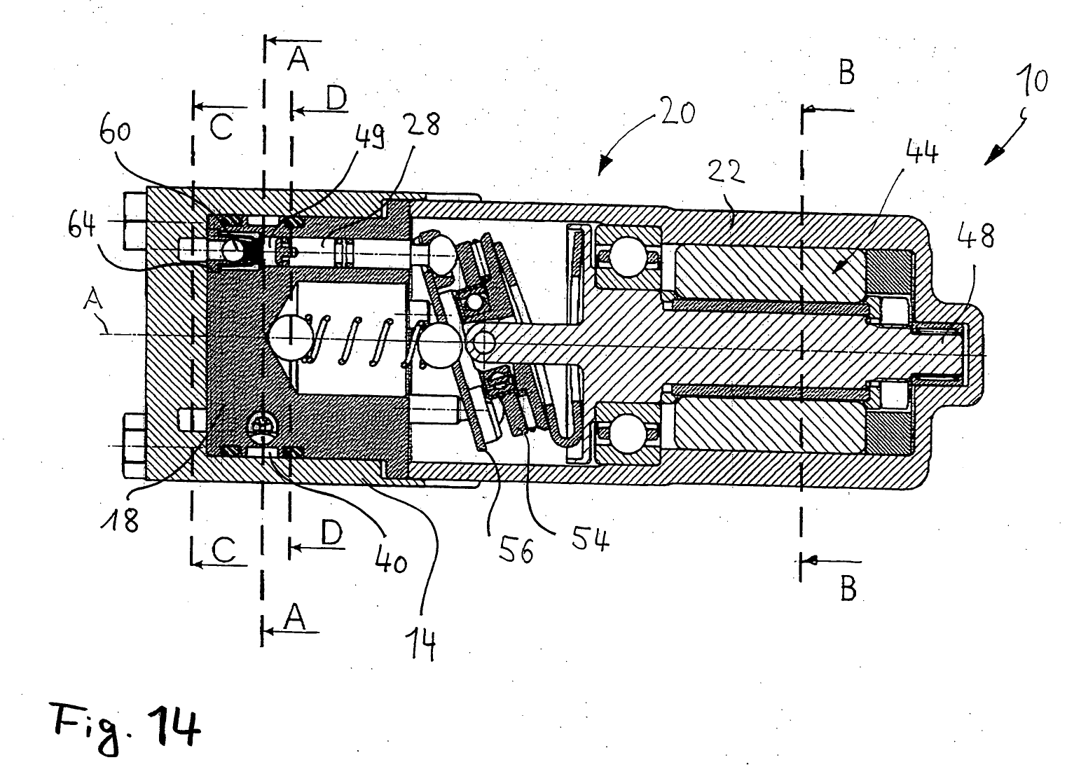

As can be inferred from the longitudinal section according to FIG. 14, the pump subassembly 12 of the pressure generator 10 according to the third embodiment differs from the first two embodiments both as regards the construction of the cylinder block 18 and also with respect to the configuration of the actuating unit 20. As far as said actuating unit 20 is concerned, an electric motor 44 having a motor shaft 48 is provided once again. In the third embodiment, however, said motor shaft 48 does not drive an eccentric, but a swash plate 54. Said swash plate 54 is coupled to a driving plate 56 in which ball-shaped end sections 58 of pumping pistons 28 are movably mounted. In contrast to the first embodiment, the cylinders 49, and also the pumping pistons 28, extend in the axial direction with respect to a longitudinal axis A of the pressure generator 10.

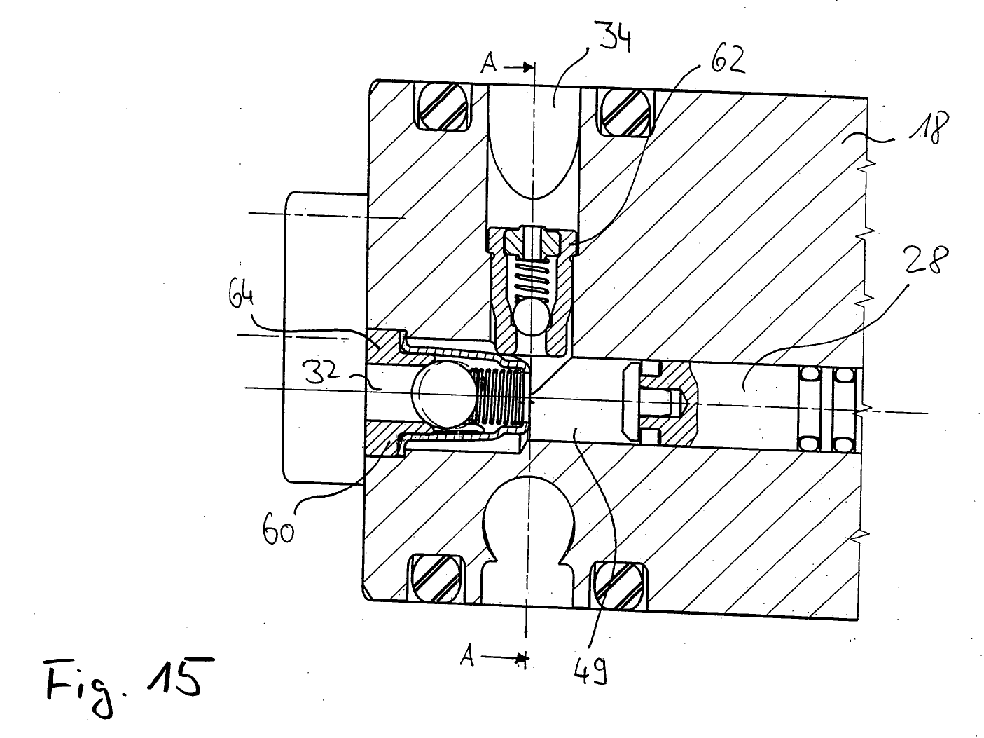

When the electric motor 44 is in operation, a rotating movement of the motor shaft 48 is transmitted to the swash plate 54 which thereupon performs a wobbling movement which is transmitted to the driving plate 56 in such a way that the pumping pistons 28 coupled to said driving plate 56 are moved to and fro in the axial direction for the purpose of conveying a hydraulic fluid. In the process, hydraulic fluid is sucked in through the inlets 32 in the cylinder block 18 and emitted under pressure via the outlets 34. Whereas the feeding-in of fluid through the inlets 32 takes place in the axial direction, said fluid is expelled through the outlets 34 in the tangential direction. This situation is also represented in FIG. 16, which shows a section along the line A-A in FIG. 15. In the sectional view according to FIG. 16, the receiving housing 14 is additionally represented with a fluid connection 24 for a hydraulic circuit.

According to FIG. 15, a valve 60, 62 is arranged, in each case, in the fluid inlets 32 and also in the fluid outlets 34. The valve 62 provided in each outlet 34 prevents hydraulic fluid from being sucked in through the outlets 34, and the valve 60 provided in each inlet 32 prevents the ejection, through the inlets 32, of hydraulic fluid which has been sucked in. The valve element 60 closes the cylinder 49 (or rather its cylinder aperture) at the end face and therefore functions as a closing element. As is represented, in particular, in FIG. 14, the valve 60 rests, with its valve foot 64, against the base of a pot-shaped clearance 40 in the housing 14. For this reason, the valve 60 can be supported against said housing 14 when the pressure generator 10 is in operation. It is therefore possible to dispense with elaborate connecting techniques (for example screwing or caulking on the cylinder block 18) for the valve foot 64.

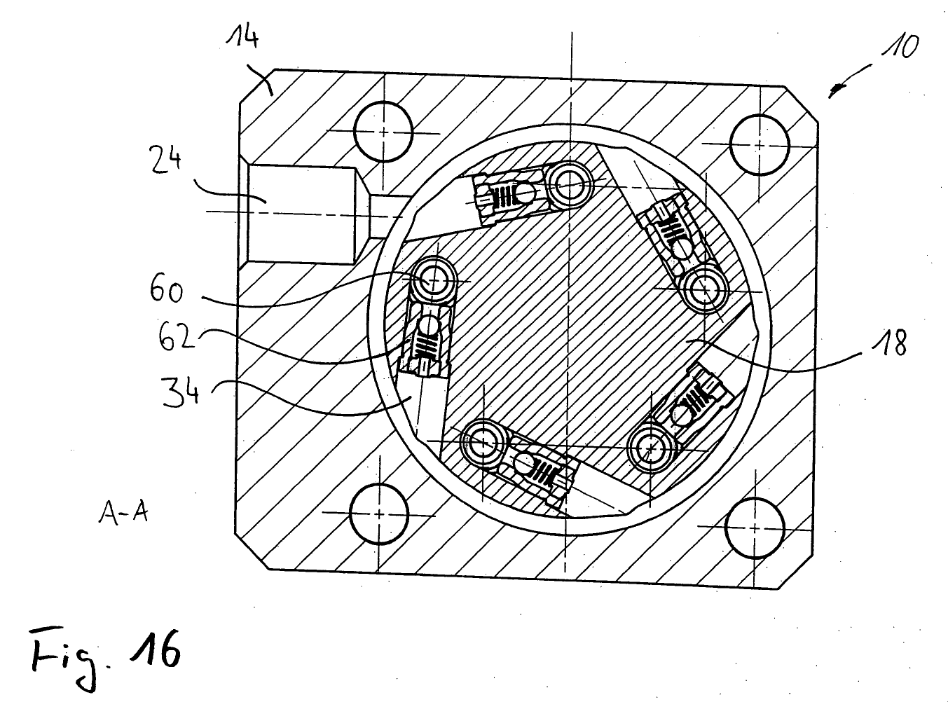

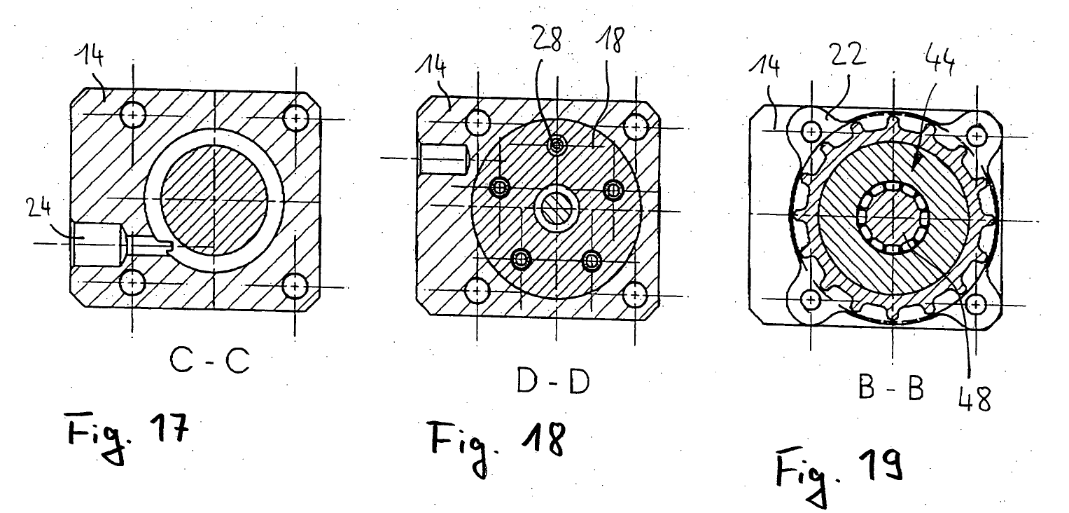

Further sectional views, perpendicular to the longitudinal axis A in FIG. 14, are represented in FIGS. 17 to 19. Thus, FIG. 17 shows a section along the line C-C, FIG. 18 a section along the line D-D and FIG. 19 a section along the line B-B.

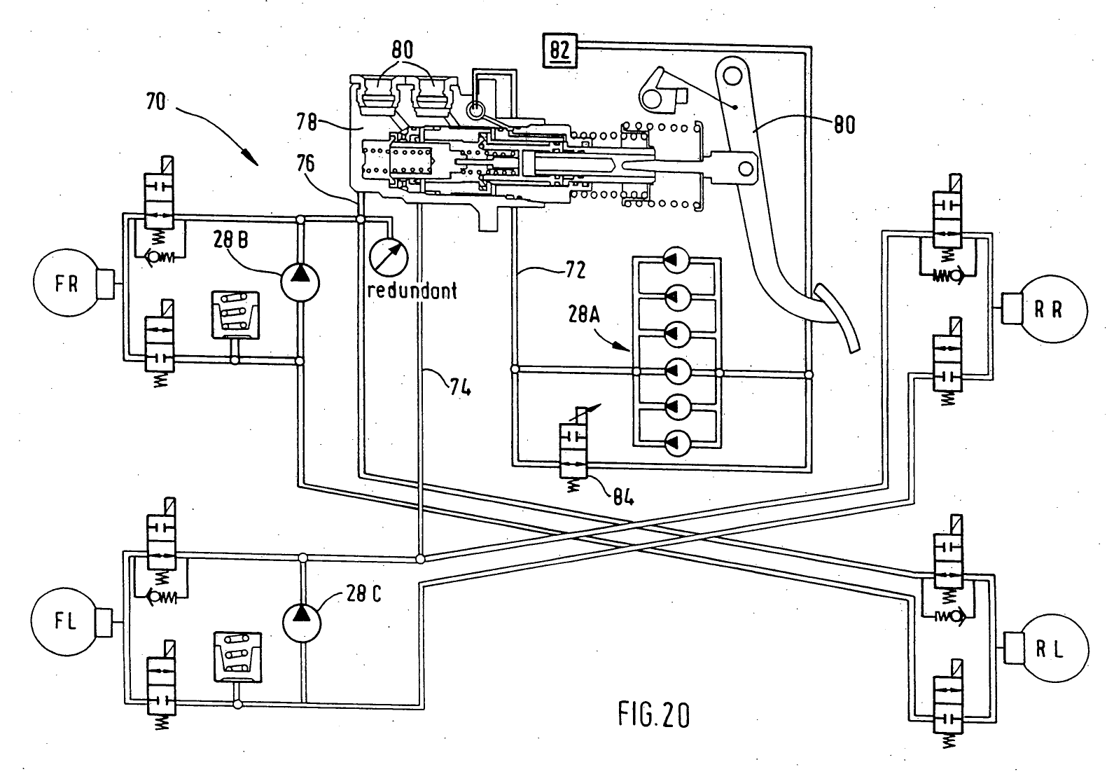

FIG. 20 shows a vehicle brake system 70 according to the invention, in which a pressure generator of the multi-piston type according to the invention is provided. All that is represented of said pressure generator in FIG. 20 is the cylinder/piston arrangements 28A, 28B and 28C, of which there are eight in all.

The vehicle brake system 70 comprises a total of three hydraulic circuits, namely a brake-force booster circuit 72 and two hydraulic circuits 74, 76 to two wheel brakes FR, RR, FL and LR, in each case. Each of these three hydraulic circuits 72, 74, 76 is coupled to a main brake cylinder 78 in known manner. Said main brake cylinder 78 can be actuated by means of a brake pedal 80 and possesses connections 80 for a source of fluid which is not represented in FIG. 20. The brake-force booster circuit 72 is likewise coupled, on the input side, to a source of fluid 82.

As can be inferred from FIG. 20, a plurality of cylinder/piston arrangements 28A, of which there are six in all, is provided in the brake-force booster circuit 72 so that the high hydraulic pressure necessary for boosting the brake force can be produced. A valve 84 is provided in a branch of the brake-force booster circuit 72 which is constructed parallel to the cylinder/piston arrangements. Said valve 84 may be incorporated in the receiving housing for the pump subassembly of the pressure generator, which generator is only represented diagrammatically in FIG. 20.

An ABS functionality is implemented for the hydraulic circuits 74, 76, and the cylinder/piston arrangements 28B, 28C function, in each case, as an ABS recirculation pump for the respective brake circuit 74, 76. Since the corresponding details and, in particular, the mode of functioning of the fluid control elements provided in the brake circuits 74, 76, are well known to the person skilled in the art, a more detailed explanation will be dispensed with here.

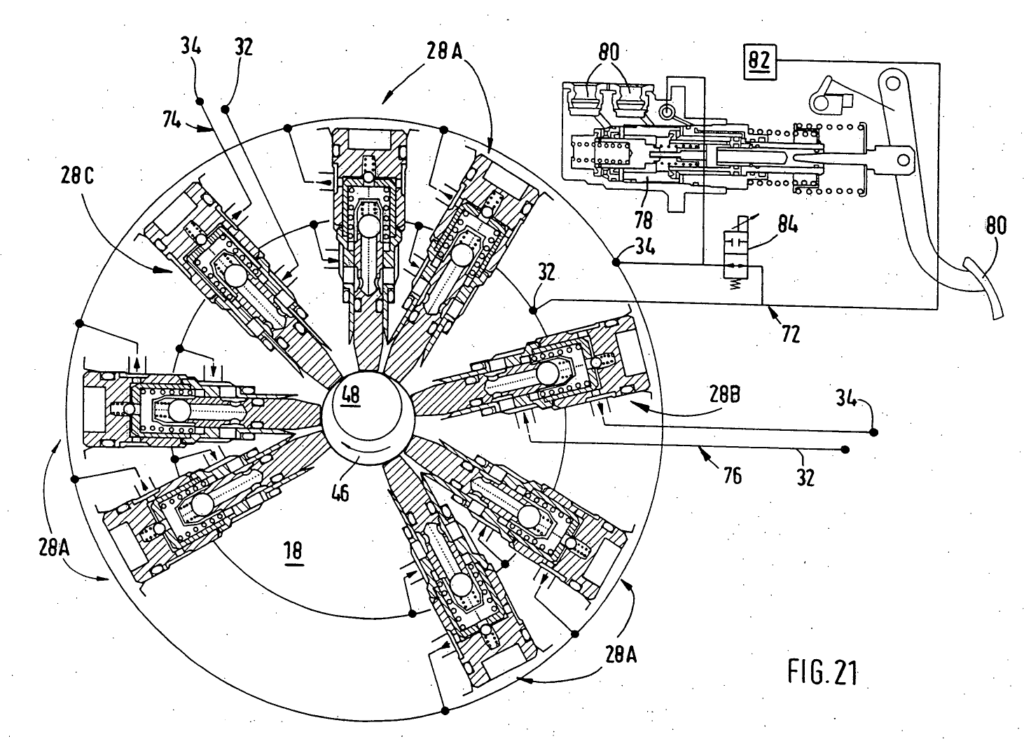

FIG. 21 shows, diagrammatically, the arrangement of the cylinder/piston arrangements, of which there are eight in all, of the vehicle brake system 70 represented in FIG. 20, wherein the reference symbols are used in the same way as in the preceding embodiments. It can be clearly seen that the two ABS cylinder/piston arrangements 28B, 28C provided in the cylinder block 18 (which is only represented diagrammatically) for the recirculation of the hydraulics are each arranged between two cylinder/piston arrangements 28A for boosting the brake force which are arranged in pairs. All eight cylinder/piston arrangements 28A, 28B, 28C are advantageously actuated by a single actuating unit, of which only the motor shaft 48 and the eccentric 46 are represented in FIG. 21. The attachment represented in FIG. 21 consequently makes it possible to provide just one pump motor for three independent hydraulic circuits.

Since a total of six cylinder/piston arrangements 28A are provided for the brake-force booster circuit 72 (that is to say, a multi-piston pump “of its own”), an adequate build-up of brake pressure can be obtained without the need to have recourse to a high-pressure or medium-pressure reservoir. Moreover, other components, such as a reservoir-charging pressure sensor or a reservoir overpressure valve are eliminated in this case. As a result of the asynchronous actuation (by means of the actuating unit comprising the eccentric 46) of the cylinder/piston arrangements 28A provided in the brake-force booster circuit 72, pressure pulsations in said circuit are smoothed to the point where the driver is not conscious, on actuating the brake pedal 80, of any reactive forces to which he is unaccustomed. Since pressure pulsations are tolerable in ABS recirculation, only a single valve/piston arrangement 28B, 28C is provided for each of the hydraulic circuits 74, 76.

In the case of the pressure generator which has been explained with reference to FIGS. 20 and 21, the regulation of pressure (still only) takes place via a magnetic valve, in which the magnetic force is set via a PWM or a current-regulating arrangement. The brake-force booster pressure is then set in dependence upon the outflow via the magnetic valve.

It is advantageous, as regards the energy balance, that in the event of brake-force boosting, the pressure generator according to FIGS. 20 and 21 merely has to produce the pressure which the driver wants (in most cases this is 5, 10, 20 or, very rarely, 30 bar). The loading on the pressure generator is correspondingly low. Admittedly, the latter has a comparatively long running time, however this is more favorable from the point of view of its working life than always having to effect delivery against high (reservoir) pressures. The pressure generator can also be switched off during pressure-maintaining and pressure-reducing phases.

As has emerged from the description of preferred embodiments, the pressure generators 10 according to the invention have a series of advantages compared to conventional pressure generators. For example, the possibility of separate operation of the pump subassembly 12, on the one hand, and of the receiving housing 14 for said subassembly 12, on the other, is advantageous. This modular attachment makes it possible to carry out servicing or repair operations on the pump subassembly 12 without having to disconnect the receiving housing 14 from the vehicle brake system.

It is also advantageous that the modular construction permits the manufacture of the receiving housing 14 and cylinder block 18 from different materials, according to the particular requirements. Thus, the cylinder block 18, which is exposed to high loadings as a result of the movements of the pumping pistons 28 within the cylinders 49, can be manufactured from a particularly wear-resistant material, while the receiving housing 14, particularly if it additionally has fluid-conducting and fluid-controlling functionalities as in the first embodiment, can be manufactured from a material, such as aluminum, which can be easily machined. It is also advantageous that, with the modular design, cylinder-closing elements such as valves or plugs can be supported against the receiving housing when the pressure generator is in operation, so that the need for elaborate connecting techniques is eliminated.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A pressure generator (10) for a vehicle brake system, comprising:
a pump subassembly (12), which can be handled individually, with
i. a cylinder block (18) with at least one inlet (32) for a hydraulic fluid and at least one outlet (34) for said hydraulic fluid, wherein in said cylinder block (18) at least one cylinder (49) is arranged in which a pumping piston (28) is received; and with
ii. an actuating unit (20) for said pumping piston (28); and
a housing (14) for receiving, at least partially, the pump subassembly (12), wherein said housing (14) has at least one first fluid connection (24) and connects the inlet (32) or outlet (34) to said first fluid connection (24).

2. The pressure generator according to claim 1, characterized in that
the first fluid connection (24) is provided for a source of fluid (82) and is connected to the inlet (32), and that the housing (14) has at least one second fluid connection (24) which is coupled to a hydraulic circuit (72, 74, 76) and connects said housing (14) to the outlet (34).

3. The pressure generator according to claim 1 or 2, characterized in that
the cylinder block (18) has at least one cylinder aperture (26) in a region adjoining the housing (14).

4. The pressure generator according to claim 3, characterized in that
the cylinder aperture (26) is bounded by a closing element (30; 60) and/or by the housing (14).

5. The pressure generator according to claim 4 or 5, characterized in that
the closing element (30; 60) is supported against the housing (14) when the pressure generator (10) is in operation.

6. The pressure generator according to one of the preceding claims, characterized in that
at least two cylinders (49), in each of which a pumping piston (28) is received, are arranged in the cylinder block (18).

7. The pressure generator according to claim 6, characterized in that
the cylinders (49) are constructed in a star-shaped manner in the cylinder block (18).

8. The pressure generator according to claim 6, characterized in that
the cylinders (49) run parallel to one another within the cylinder block (18).

9. The pressure generator according to one of claims 6 to 8, characterized in that
the actuating unit (20) actuates the pumping pistons (28) asynchronously.

10. The pressure generator according to one of the preceding claims, characterized in that
the vehicle brake system (70) comprises at least one hydraulic circuit (72), to which two or more cylinder/piston arrangements (28A) are connected.

11. The pressure generator according to one of claims 6 to 10, characterized in that
the pressure generator (10) can be coupled to two or more hydraulic circuits (72, 74, 76), and at least one cylinder/piston arrangement (28A, 28B, 28C) is provided in the cylinder block (18) for each hydraulic circuit (72, 74, 76).

12. The pressure generator according to claim 11, characterized in that
there is constructed in the cylinder block (18) at least one cylinder/piston arrangement (28A) for a brake-force booster circuit (72) and at least one other cylinder/piston arrangement (28B, 28C) each for two ABS circuits (74, 76).

13. The pressure generator according to one of the preceding claims, characterized in that
the pump subassembly (12) is arranged in a detachable manner in the housing (14).

14. The pressure generator according to one of the preceding claims, characterized in that
the housing (14) consists of a first material, preferably aluminum, and s the cylinder block (18) consists of a second material, preferably steel or grey cast iron.

15. The pressure generator according to one of the preceding claims, characterized in that
the fluid lines and fluid control elements are arranged in the housing (14).

16. The pressure generator according to one of the preceding claims, characterized in that
the actuating unit (20) possesses a housing (12) of its own, which is fastened to the cylinder block (18).

17. A method for mounting a pressure generator (10) in a vehicle brake system, comprising:
providing a housing (14) for receiving at least one section of a pump subassembly (12), wherein said housing (14) has at least one fluid connection (24);
providing a pump subassembly (12), which can be handled individually, with
i. a cylinder block (18) with at least one inlet (32) for a hydraulic fluid and at least one outlet (34) for said hydraulic fluid, wherein in said cylinder block (18) at least one cylinder (49) is arranged in which a pumping piston (28) is received; and
ii. an actuating unit (20) for said pumping piston (28);
connecting the housing (14) by the connection of the fluid connection (24) to a source of fluid (82) or to a hydraulic circuit (72, 74, 76); and
inserting the pump subassembly (12) in the housing (14), wherein the inlet (32) or outlet (34) is connected to the fluid connection (24).

18. The method according to claim 17, characterized in that
the pump subassembly (12) is inserted in the connected housing (14).

19. The method according to claim 17 or 18, characterized in that
a plurality of pump subassemblies (12) with different capacities is provided, and further comprising the step of selecting a pump subassembly (12), which is to be inserted in the housing (14), in dependence upon the capacity required.

20. The method according to one of claims 17 to 19, further comprising the additional steps of demounting a first pump subassembly (12) from the connected housing (14), and of inserting a second pump subassembly (12) in said connected housing (14).
